(19) United States
(12) Patent Application Publication
(10) Pub. No.: US 2007/0284189 A1
(43) Pub. Date: Dec. 13, 2007

(54) Ladder anchor

(76) Inventor: Saul Chady, Chicago, IL (US)

Correspondence Address: GREER, BURNS & CRAIN, 300 S WACKER DR, 25TH FLOOR, CHICAGO, IL, 60606, US

(21) Appl. No.: 11/451,829

(22) Filed: Jun. 13, 2006

(51) Int. Cl. E06C 7/42

(52) U.S. Cl. 182/107

(57) ABSTRACT

A ladder anchor configured for attachment to a side of a ladder includes a frame having at least one bracket, a spike slidably received in the at least one bracket, and a jack arm associated with the frame and configured for engaging the spike.

### BACKGROUND OF THE INVENTION

The present invention generally relates to stability enhancing attachments for ladders used in the construction, home improvement and other industries. More particularly, the present invention relates to an improved ladder anchor configured for preventing ladder slippage on uneven or unstable ground.

Ladders are well known in the art by both tradesmen and laymen alike. Although ladders are sometimes used on stable and even ground, more often, ladders are utilized where a level support or base cannot be secured, for example, on sloping ground, or where the substrate is instable, as in the case of loose sand or gravel. Under such conditions, one foot of the ladder is higher than the other, causing the ladder to be oriented at an angle with respect to the horizontal, reducing the stability and safety of the ladder, and sometimes causing the ladder to slip.

To maintain ladder stability on uneven surfaces, ladder extension devices have been developed, such as that disclosed in U.S. Pat. No. 1,624,945 to Glover, which is incorporated herein in full by reference. In Glover, the extension device is attached to the side of the ladder that needs lengthening. An adjustable spike extends from the device and is embedded into the ground until the ladder is stabilized. However, in Glover, the extension device is only provided on one side of the ladder. This orientation can add extra weight to the side having the extension device, and possibly cause instability to the ladder during use. Further, in Glover, the spike is pointed and has a radially extending flange acting as a stop when the spike is embedded into the ground. In cold or wet weather, the flange can sink into the ground, further embedding the spike and increasing the difficulty of spike removal. Also, in Glover, the spike is located relatively close to the ladder rail. Such a closely spaced orientation can cause damage to the ladder through misplaced hammer blows when the user is pounding the spike into the ground.

Other stability devices provide extension devices on both sides of the ladder, such as U.S. Pat. No. 2,145,619 to Brown, which is incorporated herein in its entirety by reference. In Brown, an anti-slippage attachment is provided on each side of the ladder, and can be placed either on the inside or the outside of the ladder rails. However, the device in Brown is only configured for use on wooden ladders, because installation of the device on metal or aluminum ladders would interfere with the rungs. Further, when using the attachment device in Brown, the user must locate and/or obtain a hammer or other tool to remove the spike from the ground.

As stated above, current anti-slippage devices generally include a spike portion that is embedded into the ground to stabilize the ladder. However, in general, the spike of current devices only penetrates approximately one inch into the ground, which can cause the ladder to slip if the spike is dislodged or placed into wet and unstable ground.

Accordingly, there is a need for an anti-slippage device for a ladder that can be provided on both ladder rails without interfering with the ladder rungs. There is also a need for an anti-slippage device that does not interfere with or cause damage to the ladder while the spike is being embedded into the ground. Further, there is a need for an anti-slippage device that provides a spike that can be embedded far enough into the ground to provide adequate support to the ladder during use on uneven or unstable ground, but that still allows easy removal of the spike. Finally, there is a need for an anti-slippage device that does not require the user to search for supplemental tools to remove the device from the ground.

### BRIEF SUMMARY OF THE INVENTION

The above-identified needs are met or exceeded by the present ladder anchor, which is configured for installation on both rails of the ladder. Further, the present ladder anchor is arranged on the ladder to avoid ladder damage during embedment of the spike into the ground. Also, the present ladder anchor includes a spike designed to be embedded deeper into the ground than current ladder anchors, but that can also be easily removed. Finally, the present ladder anchor includes a designated jack arm for removing the spike from the ground.

More specifically, the present ladder anchor is configured for attachment to a side of a ladder and includes a frame having at least one bracket, a spike slidably received in the at least one bracket, and a jack arm associated with the frame and configured for engaging the spike.

### BRIEF DESCRIPTION OF THE SEVERAL VIEWS OF THE DRAWINGS

FIG. 1 is a fragmentary top perspective view of a ladder anchor attached to an outside of a ladder rail according to the present invention;

FIG. 2 is an exploded perspective view of the present ladder anchor;

FIG. 3 is a fragmentary elevational view of the present ladder anchor as seen attached to an inside of the ladder rail;

FIG. 4 is a fragmentary front elevational view of the present ladder anchor in a storage position;

FIG. 5 is a fragmentary front elevational view of the present ladder anchor in an operating position having a spike embedded in the ground;

FIG. 6 is a fragmentary front elevational view of the present ladder anchor showing a jack arm engaging a spike jacking point;

FIG. 7 is a close-up vertical cross-section taken from point 7 of FIG. 6 of the jack arm engaging the spike jacking point; and

FIG. 8 is a fragmentary front elevational view of the present ladder anchor showing the jack arm engaging the spike jacking point and raising the spike from the ground.

### DETAILED DESCRIPTION OF THE INVENTION

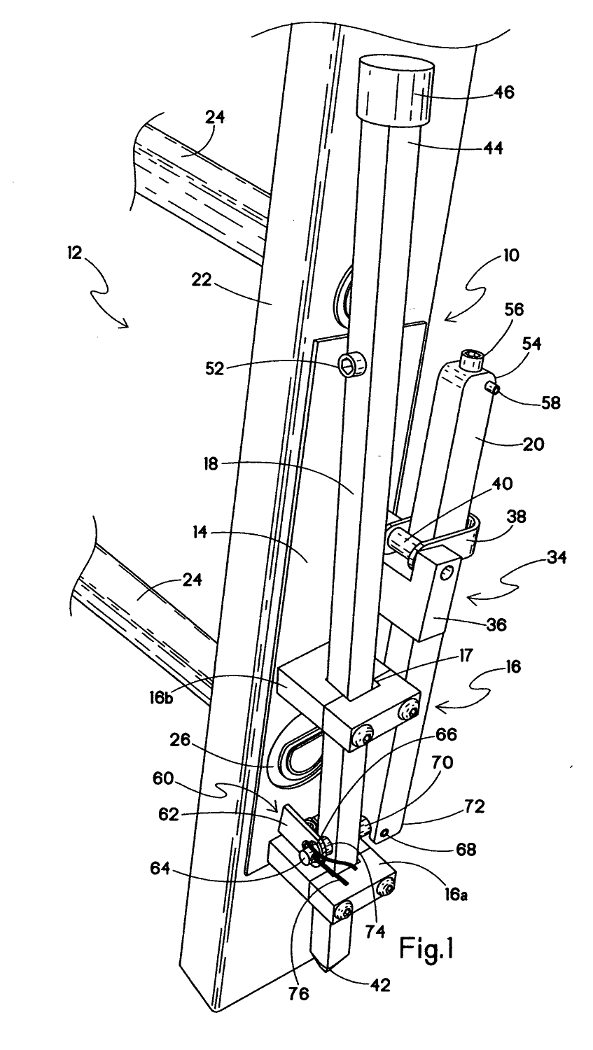

Referring now to FIG. 1, a ladder anchor according to the present invention is generally designated 10 and is configured for attachment to a ladder 12. The ladder anchor 10 includes a frame 14 having at least one bracket 16, a spike 18 slidably received in the at least one bracket, and a jack arm 20 associated with the frame and configured for engaging the spike.

As generally known in the art, the ladder 12 includes a pair of rails 22 and a plurality of rungs 24 constructed and arranged between the pair of rails in a spaced parallel orientation as is well known in the art. The ladder 12 is generally manufactured from a combination or stainless steel or aluminum and fiberglass, according to industry accepted standards as known in the art. The ladder anchor 10 is constructed and arranged for attachment to one of the rails 22 of industry standard ladders, preferably having fiberglass rails, however the anchor is mountable on aluminum or other metal ladders as well.

Referring now to FIGS. 1-3, the frame 14 is preferably manufactured from aluminum, but it is recognized that other similar materials may be suitable, as known in the art. Frame 14 has a width W generally corresponding to the width of the rails 22, and a hole 26 located on the frame for association with an end of one of the plurality of rungs 24. The frame 14 further includes a plurality of fastener holes 28 constructed and arranged for accommodating a plurality of corresponding fasteners 30. When attaching the frame 14 to one of the ladder rails 22, a user drills openings into the rail (not shown) that are aligned with the fastener holes 28, and secures the frame to the ladder rail by inserting each of the plurality of fasteners 30 into a corresponding one of the fastener holes. A washer 32 is preferably provided between the frame 14 and the fastener 30. It is contemplated that the washer 32 acts as a spacer between the frame 14 and the ladder rail 22, protecting the rail from fracture or additional stress caused by lateral forces experienced by the ladder during operation of the ladder anchor 10.

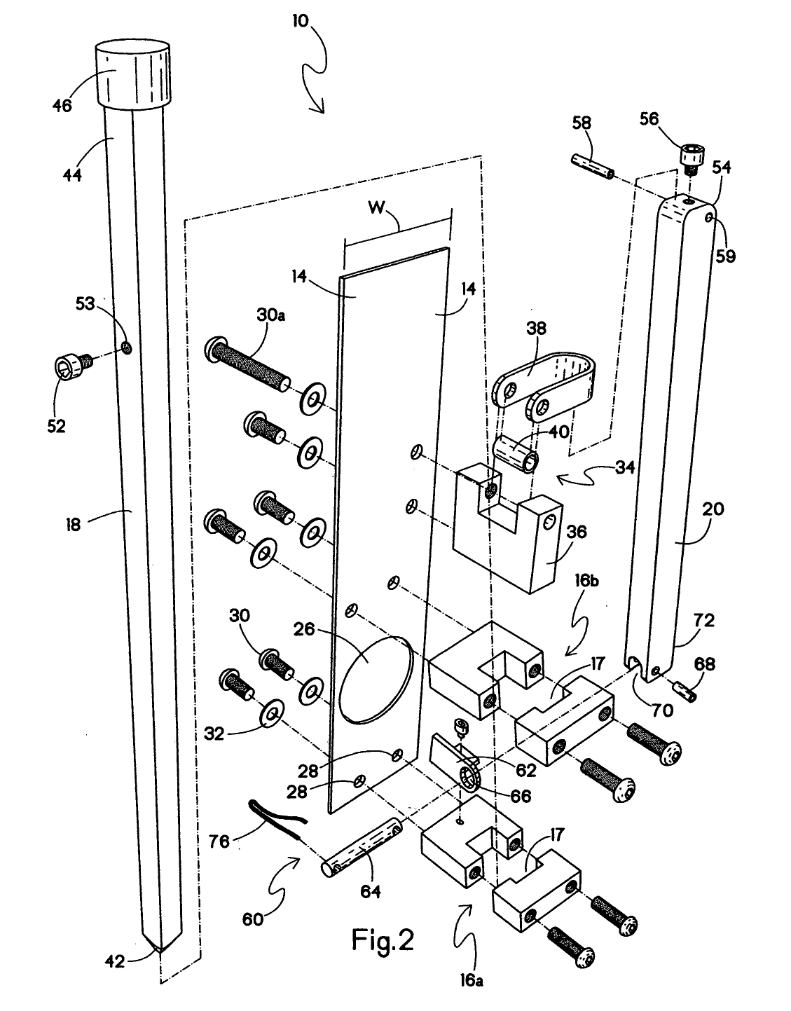

The at least one bracket 16 is preferably a pair of brackets 16a, 16b, and the pair of brackets are preferably arranged on the frame 14 substantially parallel to and offset from each other, as seen in FIG. 1. The brackets 16a, 16b are secured to the frame 14 by several of the fasteners 30, as seen in FIG. 2. Once the user has attached the frame 14 to the ladder rail 22 (as previously described), the brackets 16a, 16b will be secured to the frame. The brackets 16a, 16b each have a channel 17 configured for slidably receiving the spike 18, and can be formed of several pieces and fabricated (as illustrated), integrally formed for attachment to the frame, or even integrally formed with the frame, as by molding or casting, as known in the art. The brackets 16a, 16b are preferably manufactured from a lightweight and durable metal, such as aluminum, but it is appreciated that other materials including but not limited to other metals, plastics, or engineered materials with similar properties may be suitable.

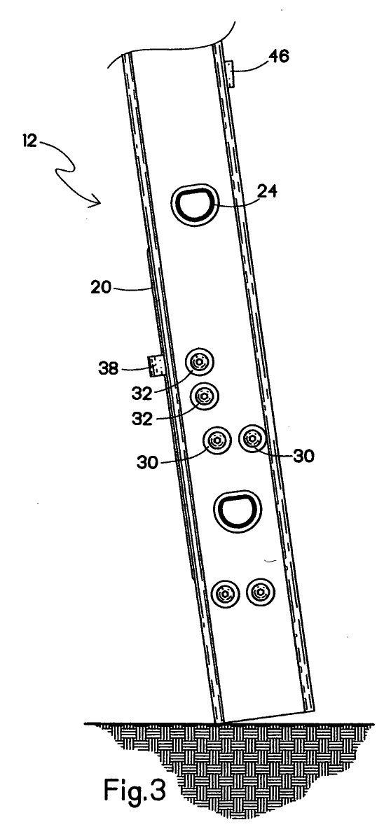

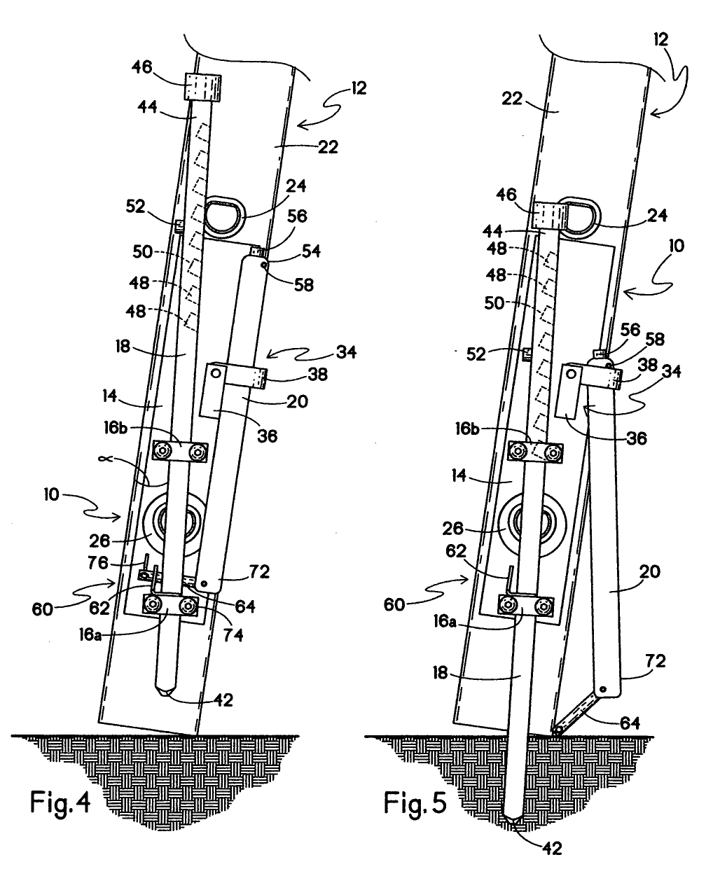

As seen in FIGS. 3-6 and 8, the frame 14 has a longitudinal axis and upon engagement in the brackets 16a, 16b, the spike 18 is arranged at an angle a to the axis (FIG. 4). Preferably, the angle a is between 10-20° and is most preferably approximately 15°. It is contemplated that due to the angle a of the spike 18, the jack arm 20 can easily engage the spike and remove it from the ground, which will be described in further detail below.

The brackets 16a, 16b slidably retain the spike 18 within the profile of the frame 14 in both a storage position (FIG. 4) and an operating position (FIG. 5). It is contemplated that by retaining the anchor 10 within the profile of the frame 14, the anchor will not interfere with the user during work, and when the anchor is in the storage position, the ladder 12 will still be easy to carry and maneuver.

Referring now to FIG. 2, the ladder anchor 10 further includes a linkage 34 constructed and arranged for receiving the jack arm 20 and enabling the jack arm to operationally engage the spike 18. The linkage 34 is preferably manufactured from a lightweight, environmentally resistant, durable material such as aluminum. However, it is recognized that other similar materials are suitable. The linkage 34 includes a support bracket 36 and a pivot bracket 38 pivotally attached to a first end of the support bracket at a tubular pivot bushing 40. Similar to the brackets 16a, 16b, the support bracket 36 is potentially fabricated, integrally formed or molded with the frame and is secured to the frame 14 by the remaining fasteners 30, as seen in FIG. 2. Pivot bracket 38 pivots about an axis defined by the tubular pivot bushing 40 and an associated fastener 30a. During operation of the anchor 10, which will be described in further detail below, the jack arm 20 pivots in the pivot bracket 38 about the fastener 30a and engages the spike 18, removing it from the ground.

The spike 18 has a first end 42 having a generally pointed shape and a second end 44 having a removable spike cap 46. As known in the art, the spike first end 42 is configured for piercing the ground. It is contemplated that the spike 18 can be hammered up to approximately 8 inches into the ground, unlike current ladder anchors and anti-slippage devices, which generally are only embedded approximately one inch into the ground. Accordingly, it is contemplated that the ladder anchor 10 provides a more stable and secure attachment within the ground when compared to current devices, decreasing the risk of ladder slippage common in sloping, wet and unstable ground.

The removable spike cap 46 is radially and axially thickened relative to the second spike end 44 for being hammered by the user during operation of the anchor 10, and is therefore subjected to repeated force. Accordingly, the spike cap 46 is removable so that it can be replaced when worn down or damaged due to repeated hammering. It is preferred that the spike cap 46 is threadably attached to the spike second end 44, preferably by an internal, threaded stud (not shown), facilitating easy removal and replacement. However, it is recognized that other means of attachment are suitable, as known in the art.

In current ladder anchors or anti-slippage devices, damage can be caused to the ladder rail during hammering of the spike into the ground. Accordingly, in the present ladder anchor 10, the brackets 16a and 16b have a height of approximately one inch so that the spike 18 is spaced approximately one inch away from the frame 14, providing clearance and preventing damage to the ladder 12 if the user misses the spike cap 46 during hammering.

Referring now to FIGS. 4-8, the spike 18 further includes a plurality of linearly spaced jacking points 48. While other dimensions and spacings are contemplated, the jacking points 48 preferably have a ½ inch diameter, and are spaced apart from each other 1 inch from their respective centers. It is contemplated that this spacing allows the jack arm 20 to more efficiently engage the jacking points 48 and remove the spike 18 from the ground. It is further preferred that the jacking points 48 are blind end bores extending approximately ⅜ of an inch deep to prevent bending or other damage to the spike, increasing the life of the spike. It is contemplated that this arrangement maintains the strength of the spike 18.

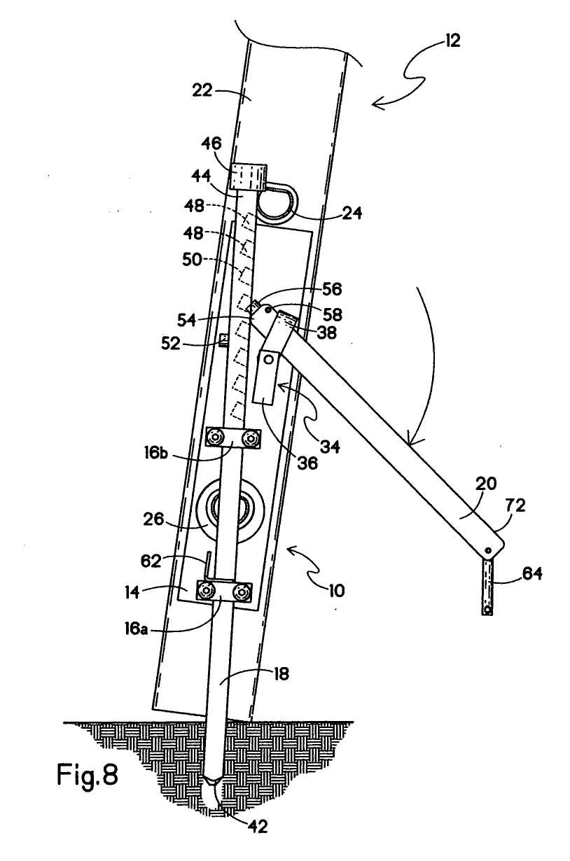

The plurality of jacking points 48 preferably each have an axis angled relative to a longitudinal axis of the spike 18, and also preferably have a flat bottom 50 (FIG. 7). More specifically, the jacking points 48 preferably each form approximately an approximate 23° angle β (FIG. 7) with respect to the longitudinal axis of the spike 18. It is contemplated that by arranging the jacking points 48 at the 23° angle β, the jacking arm 20 will readily engage the jacking points and remove the spike 18 from the ground. However, it is appreciated that other angles may be suitable, depending on the application.

The spike 18 further includes a spike stop 52 constructed and arranged for preventing the spike from being embedded too deep into the ground. The spike stop 52 projects radially from the spike 18, is preferably located between the spike second end 44 and the jacking points 48, and is preferably constructed from a threaded nut that is accommodated by a threaded bore 53 (FIG. 2). However, it is appreciated that other forms of stops may be suitable, as known in the art. The stop 52 is configured for preventing the spike 18 from falling out of the channel 17 in bracket 16b. It is contemplated that if the stop 52 becomes damaged during use of the anchor 10, it can be easily replaced without the need to replace the entire spike 18.

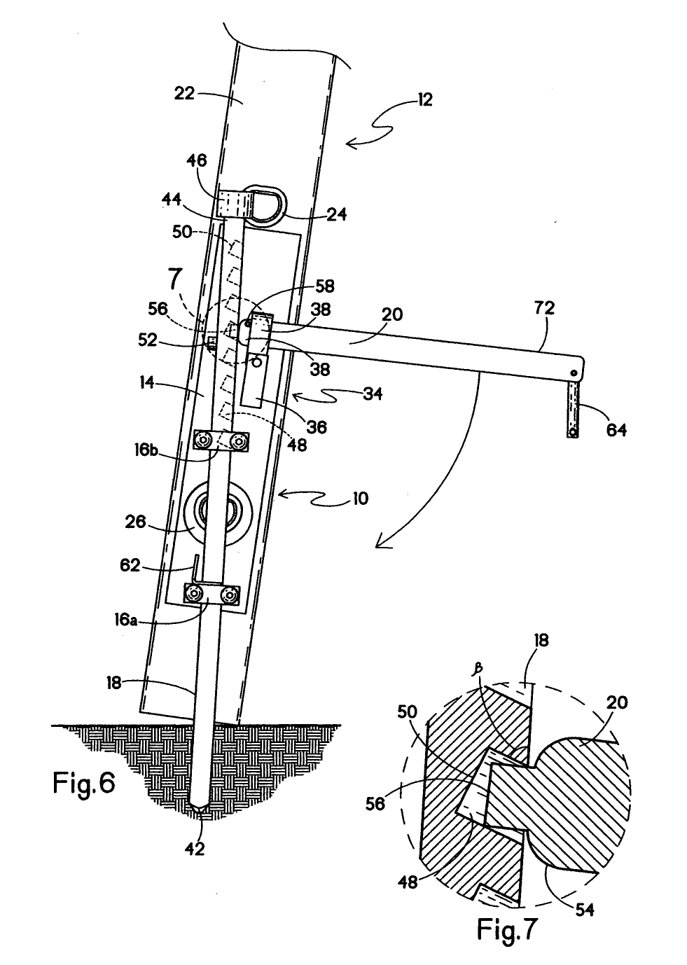

Seen in FIGS. 6-8, the jack arm 20 includes a first end 54 having a knob 56 configured for engaging each of the jacking points 48. The knob 56 is preferably cylindrical in shape and has a smaller diameter than the diameter of the jacking points 48. The jack arm 20 further includes at least one radially projecting stop 58 near the jack first end 54 configured for retaining the jack arm in the linkage 34 when the arm is not in use. The jack arm stop 58 is preferably a tubular pin and is accommodated in a pin through hole 59 near the jack arm first end 54. The jack arm stop 58 is configured for preventing the jack arm 20 from falling out of the pivot bracket 38 during operation of the jack arm. However, it is recognized that other configurations may be suitable, as known in the art.

Best seen in FIG. 2, the ladder anchor 10 further includes a pin assembly 60 constructed and arranged for releasably retaining the spike 18 to the jack arm 20. Included in the pin assembly 60 is a pin bracket 62 secured to the frame 14 and the bracket 16a, and a pin 64 configured for engaging an eyelet 66 in the pin bracket. It is contemplated that the pin bracket 62 can be separately attached to the frame 14 or the bracket 16a, or can be integrally formed with the frame or the bracket, depending on the application. The pin 64 is pivotally attached to the jack arm 20 by a pivot pin 68 located in a jack arm clevis 70 at a jack arm second end 72. The pivot pin 68 is mounted in the jack arm 20 to be transversely located in the clevis 70. The clevis 70 is configured to provide clearance for the pin 64 within the jack arm second end 72.

To secure the spike 18 to the jack arm 20 when the anchor is not in use, the user pivots the pin 64 so it can pass through the eyelet 66 and a spike through hole 74 that is aligned with the eyelet. Once the pin 64 passes through the spike 18, it is held in place by a cotter pin 76 or other locking device, as known in the art and as shown in FIG. 4. Although a specific retaining assembly has been discussed herein, it is appreciated that other arrangements for retaining the spike 18 to the jack arm 20 are suitable, as known in the art.

As seen in FIGS. 4-6, the ladder anchor 10 is moveable between the storage position (FIG. 4) and the operating position (FIG. 5). In the storage position, the spike 18 and the jack arm 20 are fastened by the pin assembly 60 generally within the width of the frame 14, and in the operating position, the jack arm is disposed for arcuate movement generally transverse to the rail 22.

In the operating position, the jack arm 20 is constructed and arranged for engaging the spike 18 with a sufficient mechanical advantage for manually extracting the spike when embedded in the ground, as seen in FIGS. 6 and 8. Specifically, after the user wishes to remove the spike 18 from the ground, the user simply pivots the jack arm 20 so that the jack arm knob 56 engages one of the jacking points 48. Once the jack arm knob 56 has engaged the jacking point 48 (FIG. 7), the user actuates the jack arm 20 in a fulcrum motion, which will begin to remove the spike 18 from the ground (FIG. 8). The user continues this process by successively engaging the adjacent jacking points 48 with the jack arm knob 56 until the spike 18 is completely removed from the ground. It is contemplated that this arrangement is superior to current anti-slippage devices because the ladder anchor 10 does not require any special or remotely located tools to remove the spike 18 from the ground.

While a particular embodiment of the present ladder anchor has been described herein, it should be appreciated by those skilled in the art that changes and modifications may be made thereto without departing from the invention in its broader aspects and as set forth in the following claims.

1. A ladder anchor configured for attachment to a side of a ladder, comprising:
a frame having at least one bracket;
a spike slidably received in said at least one bracket; and
a jack arm associated with said frame and configured for engaging said spike.

2. The ladder anchor of claim 1 wherein said at least one bracket is a pair of brackets spaced generally axially along a longitudinal axis of said frame for accommodating said spike at two points.

3. The ladder anchor of claim 2 wherein said pair of brackets are arranged on said frame substantially parallel to and offset from each other.

4. The ladder anchor of claim 3 wherein upon engagement in said brackets, said spike is arranged at an angle to said axis.

5. The ladder anchor of claim 1 wherein said anchor further includes a linkage constructed and arranged for receiving said jack arm and enabling said jack arm to operationally engage and retract said spike from the ground

6. The ladder anchor of claim 5 wherein said linkage includes at least one support bracket and at least one pivot bracket pivotally attached to a first end of said support bracket at a pivot bushing.

7. The ladder anchor of claim 1 wherein said spike has a first end having a generally pointed shape and a second end having a removable spike cap.

8. The ladder anchor of claim 5 wherein said spike further includes a plurality of linearly spaced jacking points.

9. The ladder anchor of claim 8 wherein said jack arm includes a first end having a knob configured for engaging each of said jacking points.

10. The ladder anchor of claim 1 wherein said spike has a plurality of jacking points each having an axis angled relative to a longitudinal axis of said spike.

11. The ladder anchor of claim 10 wherein each of said jacking points is a blind end bore arranged at approximately a 23° angle relative to the spike longitudinal axis.

12. The ladder anchor of claim 5 wherein said jack further includes at least one stop near a jack first end configured for retaining said jack in said linkage.

13. The ladder anchor of claim 1 further including at least one pin assembly constructed and arranged for releasably retaining said spike to said jack arm in a storage position.

14. A ladder comprising:
a pair of rails;
a plurality of rungs constructed and arranged in parallel, spaced relationship between said pair of rails; and
a ladder anchor mounted to the ladder comprising a frame having at least one bracket, a width generally corresponding to a rail width and a hole configured for association with one of said plurality of rungs, a spike slidably received in said at least one bracket, and a jack arm associated with said frame and configured for engaging and retracting said spike from a substrate.

15. The ladder of claim 14 wherein said ladder anchor is moveable between a storage position and an operating position, and wherein in said storage position, said spike and said jack arm are fastened generally within said frame width, and in said operating position, said jack arm is disposed for arcuate movement generally transverse to said rail.

16. The ladder of claim 15, wherein said jack arm includes an engagement formation and said spike includes a plurality of linearly spaced jacking points, said engagement formation constructed and arranged for engaging each of said jacking points.

17. A spike configured for use with a ladder anchor mounted to a ladder having a pair of rails and a plurality of rungs connecting the rails, the ladder anchor being mounted to one of the pair of ladder rails and including a frame having at least one bracket and a jack arm releasably attached to the frame, the spike comprising:
a plurality of jacking points configured for being engaged by the jack arm;
a first end configured for being embedded into the ground; and
a second end configured for being hammered.

18. The spike of claim 17 wherein said second end is radially and axially enlarged relative to said spike and is removably secured to an upper end of said spike and said first end is generally pointed for piercing the ground.

19. The spike of claim 17 wherein the spike has a plurality of jacking points each having an axis angled relative to a longitudinal axis of the spike, each of said jacking points being a blind end bore arranged at approximately a 23° angle relative to the spike longitudinal axis.

20. The spike of claim 19 further including a spike bore and a stop, said spike bore being located between said second end and said jacking points, said stop being a threaded fastener configured for being accommodated in said spike bore.
